(19) United States
(12) Patent Application Publication
(10) Pub. No.: US 2019/0096422 A1
(43) Pub. Date: Mar. 28, 2019

(54) SOUND GENERATION NOTIFICATION DEVICE, SOUND GENERATION NOTIFICATION METHOD, AND PROGRAM

(71) Applicant: HONDA MOTOR CO., LTD., Tokyo (JP)

(72) Inventor: Tatsuya Kyomitsu, Wako-shi (JP)

(21) Appl. No.: 16/137,621

(22) Filed: Sep. 21, 2018

(30) Foreign Application Priority Data
Sep. 28, 2017 (JP) 2017-188750

(51) Int. Cl. G10L 21/10; G10L 25/51; H04R 1/40; G09B 21/00

(52) U.S. Cl. CPC G10L 21/10; G09B 21/009; H04R 1/406; G10L 25/51

(57) ABSTRACT

A sound generation notification device includes a sound pickup unit including a plurality of microphones for collecting sounds, a sound source localization unit that performs sound source localization on the basis of an acoustic signal picked up by the sound pickup unit, a sound source separation unit that performs sound source separation on the basis of information obtained by the sound source localization, a sound source identification unit that specifies a type of sound obtained by the sound source separation, and an informing unit that informs of the type of sound of which the sound source is specified through stimulation.

### CROSS-REFERENCE TO RELATED APPLICATION

Priority is claimed on Japanese Patent Application No. 2017-188750, filed Sep. 28, 2017, the content of which is incorporated herein by reference.

### BACKGROUND OF THE INVENTION

### Field of the Invention

The present invention relates to a sound generation notification device, a sound generation notification method, and a program.

### Description of Related Art

A door phone, an interphone, or the like can inform a user of a visitor with a calling sound. In a conventional door phone, a call button is provided at an entrance. A parent device installed indoors informs of an electronic chime sound or the like according to a visitor pressing the calling button.

A person who is hard of hearing or a hearing-impaired person does not easily hear or is unable to hear the informing sound. Further, the person who is hard of hearing or the hearing-impaired person does not easily hear or is unable to hear content of speech spoken by a visitor over an interphone.

Therefore, for example, in a technology described in Japanese Unexamined Patent Application, First Publication No. 2000-134301 (hereinafter referred to as Patent Document 1), recognizing the content of speech spoken by a visitor and causing a display unit to display a result of the speech recognition as character information has been proposed.

### SUMMARY OF THE INVENTION

However, in the technology described in Patent Document 1, it is necessary to introduce a system including a speech recognition means and a display means, and to perform indoor construction. Further, in the technology described in Patent Document 1, a hearing-impaired person is likely not to notice that the visitor has come even when the spoken content is displayed on the display unit.

Aspects of the present invention has been made in view of the above problems, and an object of the present invention is to provide a sound generation notification device, a sound generation notification method, and a program capable of easily informing a hearing-impaired person that a sound has been generated.

In order to achieve the above object, the present invention adopts the following aspects.

(1) A sound generation notification device according to one aspect of the present invention includes: a sound pickup unit including a plurality of microphones for collecting sounds; a sound source localization unit that performs sound source localization on the basis of an acoustic signal picked up by the sound pickup unit; a sound source separation unit that performs sound source separation on the basis of information obtained by the sound source localization; a sound source identification unit that specifies a type of sound obtained by the sound source separation; and an informing unit that informs of the type of sound of which the sound source is specified through stimulation.

(2) In the aspect (1), the informing unit may change the stimulation for informing according to the type of sound.

(3) In the aspect (1) or (2), the informing unit may be configured by a mobile terminal and perform informing through flicker of a screen of the mobile terminal.

(4) In the aspect (3), the informing unit may be a home electric appliance and may be connected to the mobile terminal by wireless communication or wired communication.

(5) In the aspect (3) or (4), the sound generation notification device may further include a human sensor, wherein when the mobile terminal and a user are separated from each other, a type of sound may be informed by a home electric appliance located near a place at which there is the user.

(6) In any one of the aspects (1) to (5), an informing sound may be selected in advance from types of sounds specified by the sound source identification unit.

(7) In the aspect (6), a priority for informing may be set for each of the types of the sounds.

(8) A sound generation notification method according to an aspect of the present invention includes the steps of: performing, by a sound source localization unit, sound source localization on the basis of acoustic signals picked up by a plurality of microphones; performing, by a sound source separation unit, sound source separation on the basis of information obtained by the sound source localization; specifying, by a sound source identification unit, a type of sound obtained by the sound source separation; and informing, by an informing unit, the type of sound of which the sound source is specified through stimulation.

(9) A program according to an aspect of the present invention causes a computer of a sound generation notification device to execute the steps of: performing sound source localization on the basis of acoustic signals picked up by a plurality of microphones; performing sound source separation on the basis of information obtained by the sound source localization; specifying a type of sound obtained by the sound source separation; and informing the type of sound of which the sound source is specified through stimulation.

According to the above aspects (1), (8) and (9), it is possible to easily inform a hearing-impaired person that a sound has been generated.

In the case of (2) above, it is possible to notify a hearing-impaired person of the type of sound using a simple scheme.

In the case of (3) above, it is easier for the sound notification to a hearing-impaired person to be performed by flickering the screen of the mobile terminal or the like.

In the case of (4) above, for example, it is possible to connect to a television or a fluorescent lamp using wireless communication and inform the hearing-impaired person of the type of sound according to a flickering state of the television or the fluorescent lamp.

In the case of (5) above, even when the mobile terminal and the hearing-impaired person are separated from each other, it is possible to appropriately inform of the type of the sound.

In the case of (6) above, it is possible to select a sound to be informed through interaction between a hearing-unimpaired person and the hearing-impaired person.

In the case of (7) above, when a plurality of sounds are generated at the same time, it is possible to determine a sound of which the hearing-impaired person is preferentially informed.

### BRIEF DESCRIPTION OF THE DRAWINGS

FIG. 1 is a block diagram illustrating an example of a configuration of a sound generation notification device according to a first embodiment.

FIG. 2 is a diagram illustrating an example of information stored in an informing pattern storage unit according to the first embodiment.

FIG. 3 is a flowchart showing an example of a process procedure of the sound generation notification device according to the first embodiment.

FIG. 4 is a block diagram illustrating an example of a configuration of a sound generation notification device according to a second embodiment.

FIG. 5 is a diagram illustrating an example of information stored in an informing pattern storage unit according to the second embodiment.

FIG. 6 is a flowchart showing an example of a process procedure of the sound generation notification device according to the second embodiment.

FIG. 7 is a diagram illustrating an example of information stored in an informing pattern storage unit according to a modification example.

FIG. 8 is a flowchart showing an example of a setting process procedure of a sound generation notification device according to the modification example.

### DETAILED DESCRIPTION OF THE INVENTION

Hereinafter, embodiments of the present invention will be described with reference to the drawings.

### First Embodiment

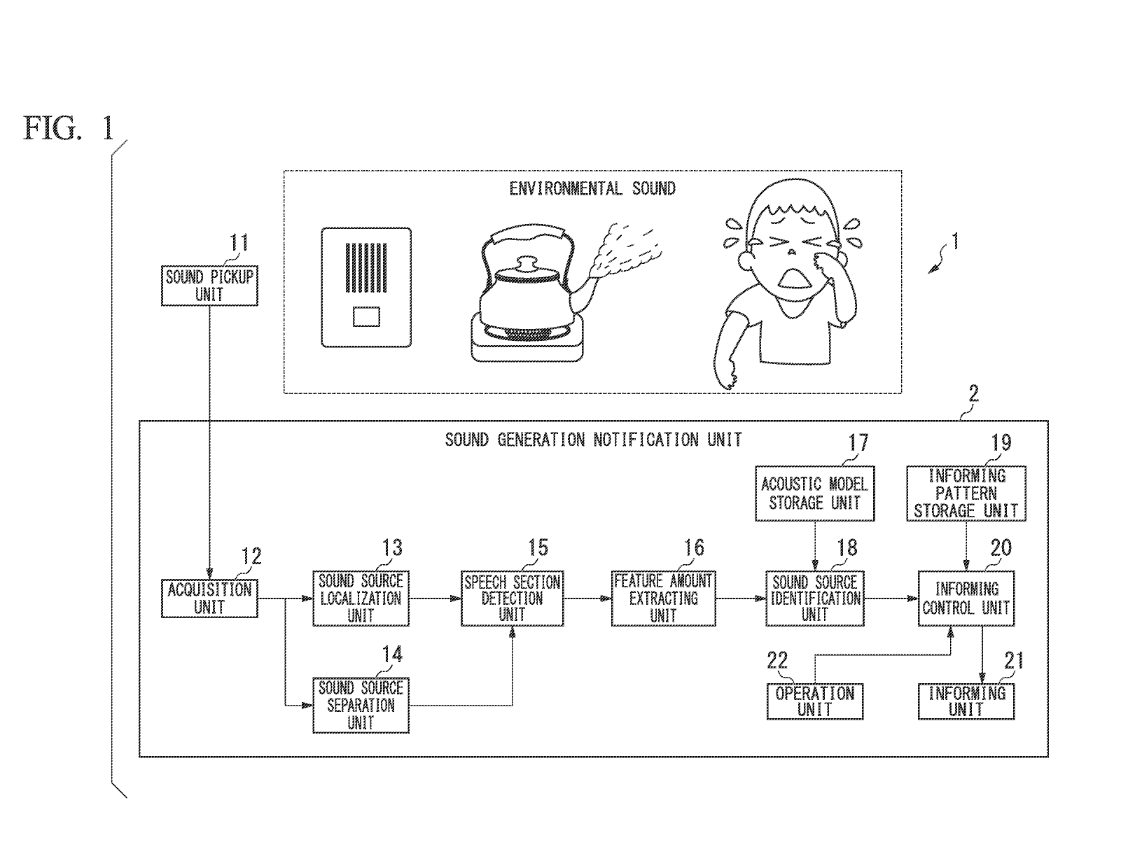

FIG. 1 is a block diagram illustrating an example of a configuration of a sound generation notification device 1 according to a first embodiment.

As illustrated in FIG. 1, the sound generation notification device 1 includes a sound pickup unit 11 and a sound generation notification unit 2. The sound generation notification unit 2 includes an acquisition unit 12, a sound source localization unit 13, a sound source separation unit 14, a speech section detection unit 15, a feature amount extraction unit 16, an acoustic model storage unit 17, a sound source identification unit 18, an informing pattern storage unit 19, an informing control unit 20, an informing unit 21, and an operation unit 22.

The sound generation notification device 1 is used, for example, in a residence in which a hearing-impaired person lives.

The sound generation notification device 1 is a mobile terminal such as a smartphone or a tablet terminal. When the mobile terminal includes two or more microphones, the sound generation notification device 1 uses the microphone included in the mobile terminal as the sound pickup unit 11. Further, when the smartphone or the like includes one microphone, the sound generation notification device 1 acquires an acoustic signal from the external sound pickup unit 11 instead of the microphone included in the smartphone or the like. In the following example, an example in which the sound generation notification device 1 includes a plurality (two or more) of microphones will be described.

The sound pickup unit 11 is a microphone array and includes Q (Q is an integer equal to or greater than 2) microphones disposed at different positions. The sound pickup unit 11 picks up the sound arriving at the own unit and generates an acoustic signal of Q channels from the picked-up sound. The sound pickup unit 11 outputs the generated acoustic signal of Q channels to the acquisition unit 12. The sound pickup unit 11 may include a data input and output interface for transmitting the acoustic signal of the Q channels wirelessly or by a wire. An environmental sound picked up by the sound pickup unit 11 includes, for example, a call chime sound (also referred to as an entrance chime) informed by a door phone or the like, an electronic sound generated by a kettle or an electric pot when hot water boils, an electronic sound generated by a washing machine when washing has ended, child's cry, an electronic sound when a bath is boiled, an electronic sound when rice is cooked, or a cry of a pet.

The acquisition unit 12 acquires the acoustic signal of Q channels output from the sound pickup unit 11 and outputs the acquired acoustic signal of Q channels to the sound source localization unit 13 and the sound source separation unit 14. It should be noted that the acquisition unit 12 converts the acquired acoustic signal as an analog signal into a digital signal, and outputs the acoustic signal converted into the digital signal to the sound source localization unit 13 and the sound source separation unit 14. The sound source localization unit 13 determines a direction of each sound source for each frame having a predetermined length (for example, 20 ms) on the basis of the sound signal of Q channels output by the acquisition unit 12 (sound source localization). The sound source localization unit 13 calculates a spatial spectrum indicating the power in each direction using, for example, a multiple signal classification (MUSIC) method in the sound source localization. The sound source localization unit 13 determines a sound source direction of each sound source on the basis of a spatial spectrum. The sound source localization unit 13 outputs sound source direction information indicating the sound source direction to the sound source separation unit 14 and the speech section detection unit 15. The sound source separation unit 14 acquires sound source direction information output from the sound source localization unit 13 and the acoustic signal of Q channels output from the acquisition unit 12. The sound source separation unit 14 separates the acoustic signal of Q channels into sound source-specific acoustic signals which are acoustic signals indicating components of each sound source on the basis of the sound source direction indicated by the sound source direction information. The sound source separation unit 14 uses, for example, a geometric-constrained high-order decorrelation-based source selection (GHDSS) method when the sound source separation unit 14 performs separation into the sound source-specific acoustic signals. The sound source separation unit 14 obtains a spectrum of the separated acoustic signal and outputs the spectrum to the speech section detection unit 15.

The speech section detection unit 15 acquires the sound source direction information output by the sound source localization unit 13 and the spectrum of the acoustic signal output by the sound source localization unit 13. The speech section detection unit 15 detects a speech section for each sound source on the basis of the acquired spectrum of the separated acoustic signal and the sound source direction information. For example, the speech section detection unit 15 performs threshold processing on an integrated spatial spectrum obtained by integrating the spatial spectrum obtained for respective frequencies using the MUSIC scheme in a frequency direction, thereby performing the sound source detection and the speech period detection at the same time. The speech section detection unit 15 outputs a detection result, the direction information, and the spectrum of the acoustic signal to the feature amount extraction unit 16.

The feature amount extraction unit 16 calculates, for each sound source, an acoustic feature amount for speech recognition from the separated spectrum output by the speech section detection unit 15. For example, the feature amount extraction unit 16 calculates the acoustic feature amount by calculating a static Mel-scale log spectrum (MSLS), a delta MSLS, and one delta power every predetermined time (for example, 10 ms). It should be noted that MSLS is obtained by performing inverse discrete cosine transform on a Mel frequency cepstrum coefficient (MFCC) using a spectral feature amount as a feature amount of acoustic recognition. The feature amount extraction unit 16 outputs the obtained acoustic feature amount to the sound source identification unit 18.

The acoustic model storage unit 17 stores a sound source model. The sound source model is a model that is used for the sound source identification unit 18 to identify the picked-up acoustic signal. The acoustic model storage unit 17 stores the acoustic feature amount of the acoustic signal to be identified, as a sound source model, in association with information indicating a sound source name for each sound source.

The sound source identification unit 18 identifies the sound source by analyzing the acoustic feature amount output by the feature amount extraction unit 16 with reference to the acoustic model stored in the acoustic model storage unit 17. The sound source identification unit 18 outputs the identification result to the informing control unit 20.

The informing pattern storage unit 19 stores the informing pattern in association with the sound source. It should be noted that the information stored in the informing pattern storage unit 19 will be described below.

The informing control unit 20 selects the informing pattern by analyzing the identification result output from the sound source identification unit 18 with reference to the informing pattern storage unit 19. The informing control unit 20 controls the informing unit 21 so that informing is performed in the selected informing pattern. In addition, the informing control unit 20 controls the informing unit 21 so that the informing is stopped, according to the operation result output by the operation unit 22.

The informing unit 21 is, for example, a functional unit that performs informing a user using stimulation, such as a light, an image display unit, a vibration motor, an odor generation device. The informing unit 21 causes the light or the image display unit to flicker under the control of the informing control unit 20. Further, the informing unit 21 changes a display color of the light or the image display unit under the control of the informing control unit 20. Further, the informing unit 21 causes the vibration motor to vibrate under the control of the informing control unit 20. Further, the informing unit 21 generates odor under the control of the informing control unit 20. That is, the informing unit 21 performs informing using a stimulus other than a sound appealing to the five senses of the user.

The operation unit 22 is, for example, a touch panel sensor provided on an image display unit when the informing unit 21 is an image display unit. Further, the operation unit 22 is an operation button or the like. The operation unit 22 detects a result of the operation of the user and outputs a result of the detection to the informing control unit 20. The operation result includes an informing stop instruction which is an instruction to stop the informing.

Next, an example of information stored in the informing pattern storage unit 19 will be described.

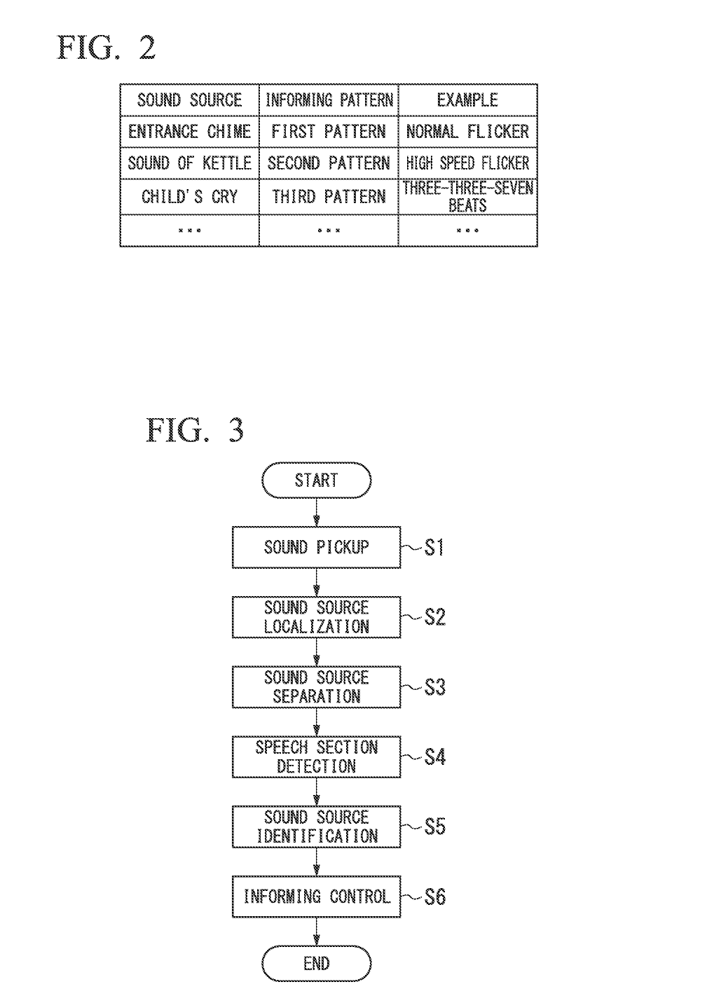

FIG. 2 is a diagram illustrating the example of the information stored in the informing pattern storage unit 19 according to the first embodiment.

It should be noted that in the example illustrated in FIG. 2, the informing unit 21 is an example of a light or an image display unit.

As illustrated in FIG. 2, the informing pattern storage unit 19 stores an informing pattern in association with a sound source for each sound source. A type of sound source is, for example, an entrance chime, a sound of a kettle when hot water boils, and child's cry. When the sound source is the entrance chime, the informing pattern is a first informing pattern. The first informing pattern is, for example, flickering at a normal speed. When the sound source is the sound of a kettle, the informing pattern is a second informing pattern. The second informing pattern is, for example, flickering at a high speed faster than the normal speed. When the sound source is a child's cry, the informing pattern is a third informing pattern. The third informing pattern is, for example, flicker of three-three-seven beats.

It should be noted that although the example in which the informing pattern storage unit 19 stores the informing pattern in association with the sound source has been described, the present invention is not limited to this example. The informing pattern for the sound source may be such that the user selects one from a plurality of informing patterns and associates the informing pattern with the sound source. (MUSIC method)

Here, a MUSIC method which is a scheme of the sound source localization will be described.

The MUSIC method is a scheme of determining a direction ϕ in which a power Pₑₓₜ(ϕ) of the spatial spectrum to be described below is maximal and higher than a predetermined level to be the localized sound source direction. In the sound source localization unit 13, a transfer function for each direction ϕ distributed at predetermined intervals (for example,5°) is stored in advance.

The sound source localization unit 13 generates a transfer function vector [D(ϕ))] having a transfer function D_{[q]}(ω) from the sound source to each microphone corresponding to each channel q (q is an integer equal to or greater than 1 and equal to or smaller than Q) as an element, for each direction ϕ.

The sound source localization unit 13 calculates a conversion coefficient ξ_{q}(ω) by converting the acoustic signal ξ_{q} of each channel q into a frequency domain for each frame having a predetermined number of elements. The sound source localization unit 13 calculates an input correlation matrix [R_{ξξ}] shown in Equation (1) from the input vector [ξ(ω)] including the calculated conversion coefficient as an element. [Math. 1]

[R_{ξξ}]=E[[ξ(ω)][ξ(ω)]*] (1)

In Equation (1), E [ . . . ] indicates an expected value of . . . , [ . . . ] indicates that . . . is a matrix or vector. [ . . . ] * indicates a conjugate transpose of the matrix or the vector.

The sound source localization unit 13 calculates an eigenvalue δₚ and an eigenvector [εₚ] of the input correlation matrix [R_{ξξ}]. The input correlation matrix [R_{ξξ}], the eigenvalue δₚ, and the eigenvector ξₚ have a relationship shown in Equation (2). [Math. 2]

[R_{ξξ}][εₚ]=δₚ[εₚ] (2)

In Equation (2), p is an integer equal to or greater than 1 and equal to or smaller than Q. An order of the index p is a descending order of the eigenvalues δₚ.

The sound source localization unit 13 calculates a power Pₛₚ(ϕ) of a frequency-specific spatial spectrum shown in Equation (3) on the basis of the transfer function vector [D(ϕ)] and the calculated eigenvector [εₚ].

$$\begin{matrix}[ Math . 3 ] & \\ {P}_{sp} ( ψ ) = \frac{\vert {[ D ( ψ ) ]}^{*} [ D ( ψ ) ] \vert}{{\sum }_{p = {D}_{m} + 1}^{Q} \vert {[ D ( ψ ) ]}^{*} [ {ɛ}_{p} ] \vert} & ( 3 )\end{matrix}$$

In Equation (3), Dₘ is a maximum number (for example, 2) of sound sources that can be detected, which is a predetermined natural number smaller than Q.

The sound source localization unit 13 calculates a sum of the spatial spectra Pₛₚ(ϕ) in a frequency band in which an S/N ratio is larger than a predetermined threshold value (for example, 20 dB) as a power Pₑₓₜ(ϕ) of the spatial spectrum in an entire band.

It should be noted that the sound source localization unit 13 may calculate the sound source localization using other schemes such as a weighted delay and a sum beam forming (WDS-BF) method, instead of the MUSIC method. (GHDSS method)

Next, a GHDSS method, which is one sound source separation scheme, will be described.

The GHDSS method is a method of adaptively calculating a separation matrix [V(ω)] so that a separation sharpness Jₛₛ([V(ω)]) and a geometric constraint J_{GC}([V(ω)]) as two cost functions decrease. In the first embodiment, a sound source-specific acoustic signal is separated from each acoustic signal acquired by each microphone array m.

The separation matrix [V(ω)] is a matrix that is used to calculate a sound source-specific acoustic signal (estimated value vector) [u′(ω)] of each of the maximum Dₘ number of detected sound sources by multiplying the separation matrix [V(ω)] by the acoustic signal [ξ(ω)] of the Q channel input from the sound source localization unit 13.

Here, [ . . . ]^{T} indicates a transpose of a matrix or a vector.

The separation sharpness J_{SS}([V(ω)]) and the geometric constraint J_{GC}([V(ω)]) are expressed by Equations (4) and (5), respectively. [Math. 4]

J_{SS}([V(ω)])=∥ϕ([u′(ω)]*−diag[ϕ([u′(ω)])[u′(ω)]*]∥² (4)

### [Math. 5]

J_{GC}([V(ω)])=∥diag[[V(ω)][D(ω)]−[I]]∥² (5)

In Equations (4) and (⁵), ∥ . . . ∥² is a Frobenius norm of the matrix . . . . The Frobenius norm is a sum of squares (scalar values) of respective element values constituting a matrix. ϕ([u′(ω)]) is a nonlinear function of the sound source-specific acoustic signal [u′(ω)], such as a hyperbolic tangent function. diag[ . . . ] indicates a sum of the diagonal elements of the matrix . . . . Therefore, the separation sharpness J_{SS}([V(ω)]) is an index value indicating a magnitude of an inter-channel non-diagonal component of the spectrum of the sound source-specific acoustic signal (estimated value), that is, a degree of a certain sound source being erroneously separated as another sound source. Also, in Equation (5), [I] indicates a unit matrix. Therefore, the geometric constraint J_{GC}([V(ω)]) is an index value indicating a degree of an error between the spectrum of the sound source-specific acoustic signal (estimated value) and the spectrum of the sound source-specific acoustic signal (sound source).

Next, an example of a process procedure of the sound generation notification device 1 will be described.

FIG. 3 is a flowchart showing the example of the process procedure of the sound generation notification device 1 according to the first embodiment.

(Step S1) The sound pickup unit 11 picks up an acoustic signal and generates an acoustic signal of Q channels generated from the picked-up acoustic signal. Subsequently, the sound pickup unit 11 outputs the generated acoustic signal of Q channels to the acquisition unit 12.

(Step S2) The sound source localization unit 13, for example, calculates a spatial spectrum indicating a power for each direction using the MUSIC method. Subsequently, the sound source localization unit 13 determines the sound source direction for each sound source on the basis of the spatial spectrum.

(Step S3) The sound source separation unit 14 separates the acoustic signal of Q channels into sound source-specific acoustic signal which is an acoustic signal indicating a component for each sound source, for example, using the GHDSS method, on the basis of the sound source direction indicated by the sound source direction information.

(Step S4) The speech section detection unit 15 detects a speech section for each sound source on the basis of the spectrum of the separated acoustic signal and the sound source direction information.

(Step S5) The feature amount extraction unit 16 calculates, for each sound source, for example, a Mel frequency cepstrum coefficient (MFCC) as an acoustic feature amount from the separated spectrum output by the speech section detection unit 15. Subsequently, the sound source identification unit 18 identifies the sound source by analyzing the acoustic feature amount output by the feature amount extraction unit 16 with reference to the acoustic model stored in the acoustic model storage unit 17. (Step S6) The informing control unit 20 selects the informing pattern by analyzing the identification result output by the sound source identification unit 18 with reference to the informing pattern storage unit 19. Subsequently, the informing control unit 20 controls the informing unit 21 so that informing is performed using the selected informing pattern.

Here, a specific example of the process illustrated in FIG. 3 will be described.

When a visitor pushes a door phone installed at an entrance, a parent device installed indoors informs of an entrance chime.

The sound generation notification device 1 picks up the entrance chime and identifies that an acoustic signal picked up is the “entrance chime”. The sound generation notification device 1 selects the informing pattern of the first pattern according to a result of the identification. Accordingly, the sound generation notification device 1 flickers the informing unit 21, which is the image display unit, at a normal speed. It should be noted that the number of flickers may be a predetermined number of times or may be until the user notices and performs an informing stop instruction. It should be noted that the user operates the operation unit 22 included in the sound generation notification device 1 and performs the informing stop instruction.

As described above, in the first embodiment, the sound pickup unit 11 including the plurality of microphones for collecting sounds, the sound source localization unit 13 that performs the sound source localization on the basis of the acoustic signals picked up by the sound pickup unit 11, the sound source separation unit 14 that performs sound source separation on the basis of information obtained by the sound source localization, the sound source identification unit 18 that identifies the type of sound obtained by the sound source separation, and the informing unit 21 that performs informing according to the type of sound of which the sound source is identified are included.

Thus, according to the first embodiment, it is possible to notify a hearing-impaired person of the type of sound using a simple scheme.

Further, in the first embodiment, the informing pattern of stimulation is changed for each identified sound source. Thus, according to the first embodiment, it is possible to notify the user of the type of sound that is ringing indoors. As a result, since the user can recognize a ringing sound source according to the informing pattern, the user can respond accordingly.

Further, according to the first embodiment, the sound generation notification unit 2 is a smartphone and is often carried by the user or placed near the user. Therefore, according to the first embodiment, it is possible to inform the user who is a hearing-impaired person of the type of sound by flickering the display of the informing unit 21, which is an image display unit of the smartphone or the like, or causing vibration, with the informing pattern corresponding to the sound when the sound rings.

### Second Embodiment

In the first embodiment, an example in which informing is performed using the informing unit 21 included in the sound generation notification unit 2 has been described, but the present invention is not limited thereto. The informing unit may be an external device connected to the sound generation notification unit 2.

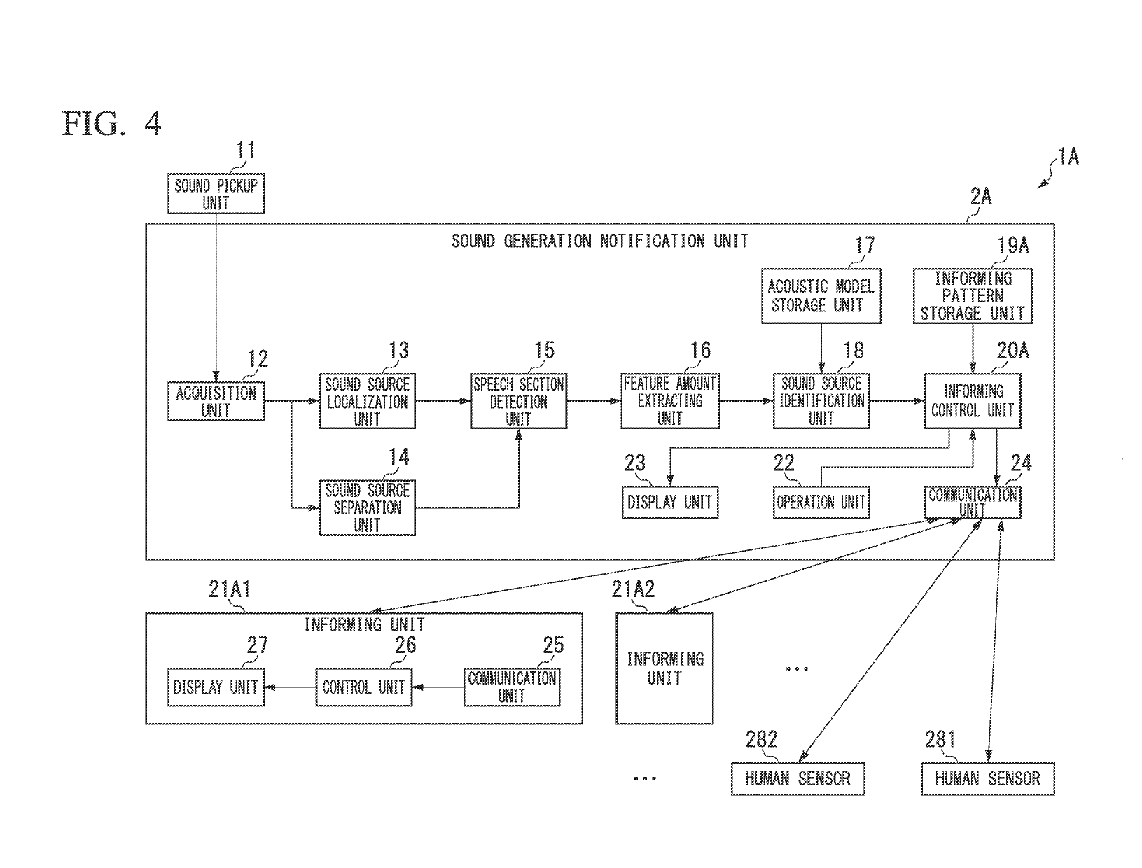

FIG. 4 is a block diagram illustrating an example of a configuration of a sound generation notification device 1A according to the second embodiment. As illustrated in FIG. 4, the sound generation notification device 1A includes a sound pickup unit 11, a sound generation notification unit 2A, an informing unit 21A1, an informing unit 21A2, . . . .

The sound generation notification unit 2A includes an acquisition unit 12, a sound source localization unit 13, a sound source separation unit 14, a speech section detection unit 15, a feature amount extraction unit 16, an acoustic model storage unit 17, a sound source identification unit 18, an informing pattern storage unit 19A, an informing control unit 20A, an operation unit 22, a display unit 23, and a communication unit 24.

Each of the informing unit 21A1, the informing unit 21A2, . . . includes a communication unit 25, a control unit 26, and a display unit 27. It should be noted that when one of the informing unit 21A1, the informing unit 21A2, . . . is not specified, the informing units are referred to as an informing unit 21A.

Further, a human sensor 281, a human sensor 282, . . . are included. It should be noted that when one of the human sensor 281, the human sensor 282, . . . is not specified, the human sensors are called a human sensor 28.

It should be noted that functional units having the same functions as those of the sound generation notification device 1 are denoted by the same reference numerals, and description thereof is omitted.

The sound generation notification device 1A performs the sound source localization, the sound source separation, the speech section detection, and the sound source identification on the acoustic signal picked up by the sound pickup unit 11, and selects the informing pattern on the basis of a result of the sound source identification. The sound generation notification device 1A transmits informing pattern information indicating the selected informing pattern to the informing unit 21A.

The informing pattern storage unit 19A stores the informing pattern in association with the sound source. Further, the informing pattern storage unit 19A stores the position at which the informing unit 21A is installed.

The informing control unit 20A selects the informing pattern by analyzing the identification result output by the sound source identification unit 18 with reference to the informing pattern storage unit 19A. The informing control unit 20A specifies a place at which there is the user on the basis of the identification information included in the detection result of the human sensor 28 output by the informing unit 21A. The informing control unit 20A transmits the informing pattern information indicating the selected informing pattern to the informing unit 21A that is at the place at which there is the user. Further, the informing control unit 20A transmits informing stop information for stopping the informing to the informing unit 21A that is at the place at which there is the user according to the operation result output by the operation unit 22. It should be noted that the informing control unit 20 may control the display unit 23 so that the informing is performed using the selected informing pattern.

The display unit 23 is, for example, a liquid crystal display device, an organic electro luminescence (EL) display device, or an electronic ink display device. The display unit 23 displays information according to the control of the informing control unit 20A. In addition, the display unit 23 may notify of the informing pattern under the control of the informing control unit 20A.

The communication unit 24 transmits the informing pattern information output from the informing control unit 20A to the informing unit 21A. The communication unit 24 receives the detection result of the human sensor transmitted by the informing unit 21, and outputs the received detection result of the human sensor to the informing control unit 20A. It should be noted that communication means between the sound generation notification device 1A and the informing unit 21A may be wireless communication or may be wired communication.

The informing unit 21A is, for example, a home electric appliance such as a fluorescent lamp, a light, a television, a smartphone, or a tablet terminal. Under the control of the informing control unit 20A, the informing unit 21A flickers the display unit 27 such as the light, the television, the smartphone, or the tablet terminal.

The communication unit 25 receives the informing pattern information transmitted by the sound generation notification unit 2A and outputs the received informing pattern information to the control unit 26.

The control unit 26 performs control so that the display unit 27 flickers according to the informing pattern information output from the communication unit 25.

The display unit 27 is an image display unit. The display unit 27 flickers an image display unit under the control of the control unit 26.

The human sensor 28 is installed, for example, on a ceiling of each room (including a restroom or a bathroom). The human sensor 28 includes a communication unit. The human sensor 28 detects that there is the user and transmits a detection result indicating that there is the user to the sound generation notification unit 2A when the human sensor 28 detects that there is the user. Identification information for identifying the human sensor 28 is included in the transmission signal. The human sensor 28 is, for example, at least one of a thermal sensor, an optical sensor, a sound wave sensor, and a sound sensor. The thermal sensor detects heat of the user by detecting a change in temperature using infrared light and detects a location of the user. The optical sensor detects a location of the user by detecting a size, a length, a displacement, or the like of the object using light with different wavelengths. The sound wave sensor detects the location of the user by detecting a size, a length, a displacement, or the like of the object using sound waves. The sound sensor detects the location of the user by detecting the sound.

It should be noted that the informing unit 21A may include the human sensor 28. In this case, the informing unit 21A may transmit information indicating that it is detected that there is the user, which includes the identification information for identifying the own device.

Next, an example of information stored in the informing pattern storage unit 19A will be described.

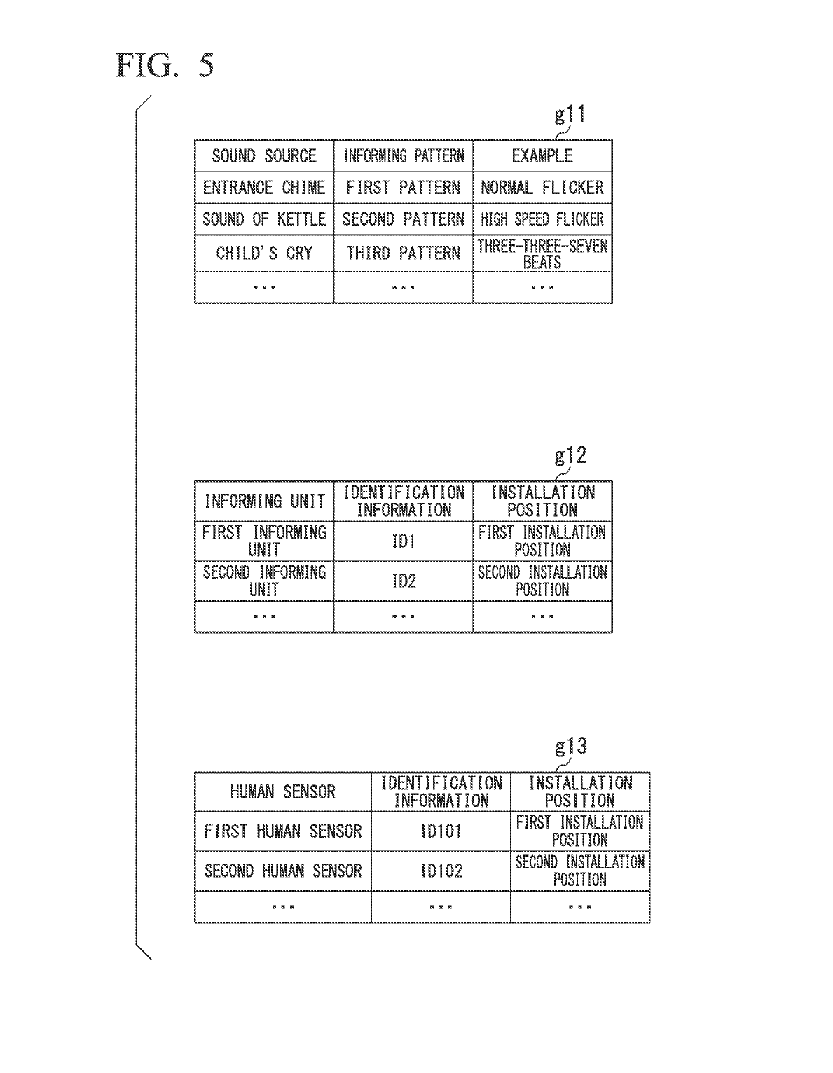

FIG. 5 is a diagram illustrating an example of the information stored in the informing pattern storage unit 19A according to the second embodiment.

As indicated by reference sign gll in FIG. 5, the informing pattern storage unit 19A stores the informing pattern in association with the sound source for each sound source. It should be noted that, similar to the first embodiment, an example in which the informing pattern storage unit 19A stores the informing pattern in association with the sound source in advance has been described, but the present invention is not limited to this example.

The informing pattern for the sound source may be such that the user selects one from a plurality of informing patterns and associates the informing pattern with the sound source.

Further, as indicated by a reference sign g12 in FIG. 5, the informing pattern storage unit 19A stores identification information and an installation position in association with each of the informing units 21A. For example, the informing pattern storage unit 19A stores identification information ID1 and a first installation position in association with the first informing unit 21A1.

Further, as indicated by a reference sign g13 in FIG. 5, the informing pattern storage unit 19A stores the identification information and the installation position in association with each human sensor 28. For example, the informing pattern storage unit 19A stores identification information ID 101 and the first installation position in association with the first human sensor 281.

Next, an example of a process procedure of the sound generation notification device 1A will be described.

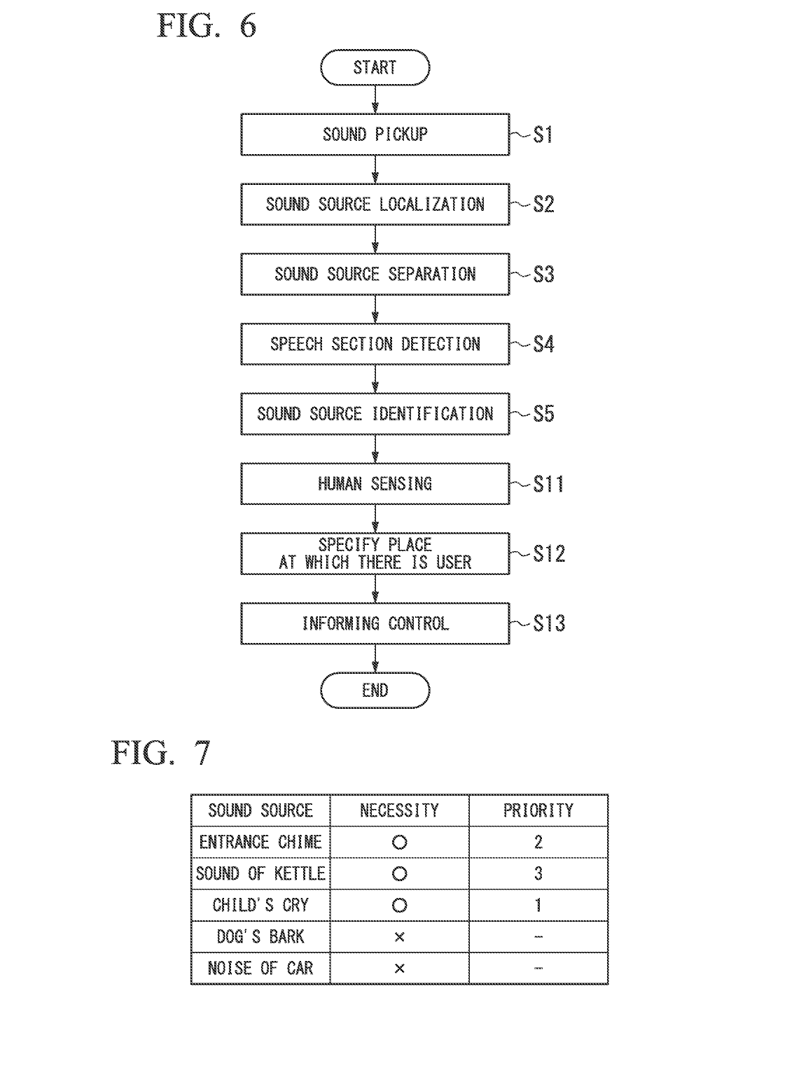

FIG. 6 is a flowchart showing an example of the process procedure of the sound generation notification device 1A according to the second embodiment.

(Steps S1 to S5) The sound generation notification device 1A performs processes of steps S1 to S5 and proceeds to a process of step S11.

(Step S11) The human sensor 28 detects that there is a user, and when human sensor 28 detects that there is the user, the human sensor 28 transmits a detection result indicating that there is the user to the sound generation notification unit 2A.

(Step S12) The informing control unit 20A specifies a place at which there is the user on the basis of the identification information included in the detection result of the human sensor 28.

(Step S13) The informing control unit 20A selects the informing pattern by analyzing the identification result output by the sound source identification unit 18 with reference to the informing pattern storage unit 19A. Subsequently, the informing control unit 20A controls the informing unit 21A installed at a position close to the place at which there is the user so that informing is performed using the selected informing pattern.

The informing control unit 20A may store the acoustic feature amount of the picked-up sound signal in the informing pattern storage unit 19A in the above process.

Here, a specific example of the process illustrated in FIG. 6 will be described.

The informing unit 21A1 is a television set and is installed in a living room. The informing unit 21A2 is a light and is installed in a bedroom. The informing unit 21A3 is a light and is installed in a restroom. It is assumed that the user is in a room.

The sound pickup unit 11 picks up a child's cry and transmits the sound to the sound generation notification unit 2A.

The human sensor 281 installed in the living room detects that there is the user and transmits a detection result to the sound generation notification unit 2A.

The sound generation notification unit 2A identifies that the acquired acoustic signal is a “child's cry”. The sound generation notification unit 2A selects the informing pattern of the third pattern according to an identification result. In addition, the sound generation notification unit 2A specifies that there is the user in the living room in which the human sensor 281is installed. The sound generation notification unit 2A transmits the informing pattern of the third pattern to the informing unit 21A1 installed at a position close to the living room in which there is the user.

The informing unit 21A1 performs control so that the display of the display unit 27 flickers with three-three-seven beats according to the received informing pattern. It should be noted that the flickering may be performed until the user notices this and operates the operation unit 22 for an informing stop instruction. It should be noted that the user operates the operation unit 22 included in the sound generation notification unit 2A to perform the informing stop instruction.

It should be noted that although the example in which the sound generation notification unit 2A and the informing unit 21A are separated has been described in the example illustrated in FIG. 4, each of the informing units 21A may include the sound generation notification unit 2A.

As described above, in the second embodiment, the sound source localization, the sound source separation, and the sound source identification are performed by the sound generation notification unit 2A, which is a smartphone or the like. Further, in the second embodiment, the informing unit 21A is a television, a light, or the like including the communication unit 25. In the second embodiment, the position at which there is the user is specified on the basis of the detection result of the human sensor 28, and the informing pattern information corresponding to the identified sound source is transmitted to the informing unit 21A installed at the specified position.

According to the second embodiment, when the sound generation notification unit 2A is placed in the living room and the user is in the restroom, it is possible to inform the user through informing using light installed in the restroom. That is, according to the second embodiment, even when the sound generation notification unit 2A such as a smartphone and the user are separated from each other, informing is performed by the informing unit 21A at a position at which there is the user. Thus, it is possible to appropriately inform of the type of sound.

It should be noted that although the example in which the speech section detection unit 15 is included has been described in the first embodiment and the second embodiment, the speech section detection unit 15 may not be included.

Further, in the first embodiment and the second embodiment, for example, a television, an artificial intelligence (AI) speaker, or the like may include the sound source localization unit 13 and the like.

### [Modification Example]

It should be noted that the example in which the informing pattern storage unit 19 (or 19A) stores the informing patterns in association with the sound sources in advance has been described in the first embodiment and the second embodiment, but the present invention is not limited to this example. The user may set whether or not the informing is performed according to the sound source in advance. Further, when a plurality of sounds are simultaneously generated, the priority may be set.

Such a modification example will be described while taking the configuration of the sound generation notification device 1 (FIG. 1) as an example. It should be noted that the modification example can also be applied to the sound generation notification device 1A.

FIG. 7 is a diagram illustrating an example of information stored in the informing pattern storage unit according to the modification example.

As illustrated in FIG. 7, the informing pattern storage unit 19 stores the necessity of informing and a priority in association with the sound source for each sound source. In the example illustrated in FIG. 7, sound sources include entrance chime, the sound of a kettle, a child's cry, a dog's bark, and the noise of a car. In addition, the sound sources for which informing is performed are the entrance chime, the sound of the kettle, and the child's cry. Sound sources for which the informing is not performed are those of a dog's bark and the noise of a car. Furthermore, a priority of informing is such that the child's cry is first, the entrance chime is second, and the sound of the kettle is third.

Next, an example of a process procedure of the sound generation notification device 1 in the modification example will be described.

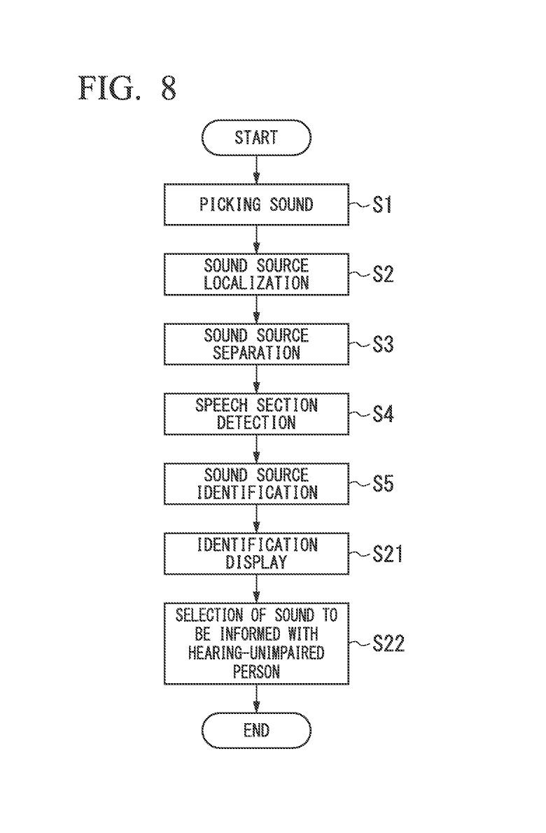

FIG. 8 is a flowchart showing an example of a setting process procedure of the sound generation notification device 1 according to the modification example. It should be noted that it is assumed that the informing unit 21 includes an image display unit.

(Steps S1 to S5) The sound generation notification device 1 performs the processes of steps S1 to S5 and proceeds to a process of step S21.

(Step S21) The informing control unit 20 causes the identification result output by the sound source identification unit 18 to be displayed on the informing unit 21.

That is, the informing control unit 20 causes a type of sound to be displayed on the informing unit 21.

(Step S22) The informing control unit 20 performs a selection of a sound to be informed or a selection of the priority according to a result of the user investigating the operation unit 22.

A specific example of the setting process in FIG. 8 will be described.

A user who is a hearing-impaired person performs a process together with a hearing-unimpaired person.

For example, the hearing-unimpaired person presses a call button of a child device of a door phone installed at an entrance. Accordingly, an “entrance phone” is displayed on the informing unit 21. The user selects whether or not the informing is performed when the “entrance phone” is detected with the hearing-unimpaired person by operating the operation unit 22. The sound generation notification device 1 causes an indication whether or not the informing is performed when the “entrance phone” is detected, to be stored in the informing pattern storage unit 19 according to a result of the operation. In addition, the user selects the priority of performing informing when the “entrance phone” is detected with the hearing-unimpaired person by operating the operation unit 22. The sound generation notification device 1 causes the priority for performing informing when the” entrance phone” is detected to be stored in the informing pattern storage unit 19 according to a result of the operation.

By repeating such a process, the necessity of informing and the priority illustrated in FIG. 7 are set.

As described above, according to the modification example, the necessity of informing is set for the identified sound in advance.

Accordingly, according to the modification example, the user can select and set a sound to be informed with the hearing-unimpaired person.

Further, according to the modification example, a priority for informing is set for the identified sounds in advance. Accordingly, according to the modification example, the user can select and set a sound to be preferentially informed with the hearing-unimpaired person.

It should be noted that a program for realizing all or some of functions of the sound generation notification unit 2 (or 2A) and the informing unit 21 (or 21A) in the present invention may be recorded on a computer-readable recording medium, and the program recorded on this computer-readable recording medium may be loaded onto and executed by a computer system so that all or some of the processes performed by the sound generation notification unit 2 (or 2A) and the informing unit 21 (or 21A) can be performed. It should be noted that the “computer system” described herein includes an OS or hardware such as a peripheral device. Further, the “computer system” also includes a WWW system including a homepage providing environment (or display environment). Further, the “computer-readable recording medium” includes a storage device such as a flexible disk, a magneto-optical disc, a read only memory (ROM), a portable medium such as a CD-ROM, or a hard disk built in the computer system. Further, the “computer-readable recording medium” also includes a recording medium that holds a program for a certain time, such as a volatile memory (RAM) inside a computer system including a server and a client when a program is transmitted over a network such as the Internet or a communication line such as a telephone line.

Further, the program may be transmitted from a computer system in which the program is stored in a storage device or the like to other computers via a transfer medium or by transfer waves in the transfer medium. Here, the “transfer medium” for transferring the program refers to a medium having a function of transferring information, such as a network (communication network) such as the Internet or a communication line such as a telephone line. Further, the program may be a program for realizing some of the above-described functions. Further, the program may be a program capable of realizing the above-described functions in combination with a program previously stored in the computer system, that is, a so-called differential file (differential program).

Although the modes for carrying out the present invention has been described above using the embodiments, the present invention is not limited to the embodiments at all, and various modifications and substitutions can be made without departing from the gist of the present invention.

What is claimed is:

1. A sound generation notification device, comprising:
a sound pickup unit including a plurality of microphones for collecting sounds;
a sound source localization unit that performs sound source localization on the basis of an acoustic signal picked up by the sound pickup unit;
a sound source separation unit that performs sound source separation on the basis of information obtained by the sound source localization;
a sound source identification unit that specifies a type of sound obtained by the sound source separation; and
an informing unit that informs of the type of sound of which the sound source is specified through stimulation.

2. The sound generation notification device according to claim 1, wherein the informing unit changes the stimulation for informing according to the type of sound.

3. The sound generation notification device according to claim 1, wherein the informing unit is configured by a mobile terminal and performs informing through flicker of a screen of the mobile terminal.

4. The sound generation notification device according to claim 3, wherein the informing unit is a home electric appliance and is connected to the mobile terminal by wireless communication or wired communication.

5. The sound generation notification device according to claim 3, further comprising a human sensor,
wherein when the mobile terminal and a user are separated from each other, a type of sound is informed by a home electric appliance located near a place at which there is the user.

6. The sound generation notification device according to claim 1, wherein an informing sound is selected in advance from types of sounds specified by the sound source identification unit.

7. The sound generation notification device according to claim 6, wherein a priority for informing is set for each of the types of the sounds.

8. A sound generation notification method, comprising the steps of:
performing, by a sound source localization unit, sound source localization on the basis of acoustic signals picked up by a plurality of microphones;
performing, by a sound source separation unit, sound source separation on the basis of information obtained by the sound source localization;
specifying, by a sound source identification unit, a type of sound obtained by the sound source separation; and
informing, by an informing unit, the type of sound of which the sound source is specified through stimulation.

9. A program causing a computer of a sound generation notification device to execute the steps of:
performing sound source localization on the basis of acoustic signals picked up by a plurality of microphones;
performing sound source separation on the basis of information obtained by the sound source localization;
specifying a type of sound obtained by the sound source separation; and
informing the type of sound of which the sound source is specified through stimulation.
